(19) United States
(12) Patent Application Publication
(10) Pub. No.: US 2025/0325854 A1
(43) Pub. Date: Oct. 23, 2025

(54) FIRE PROTECTION DEVICE COMPRISING A FIRE PROTECTION BLANKET

(71) Applicant: RIESTER GMBH, Aspach (DE)

(72) Inventor: Jörg PFEIFFER, Aspach (DE)

(21) Appl. No.: 18/870,644

(22) PCT Filed: May 17, 2023
(86) PCT No.: PCT/EP2023/063379

§ 371 Date: Nov. 30, 2024

(30) Foreign Application Priority Data
Jun. 2, 2022 (DE) 20 2023 103 126.6

(51) Int. Cl. A62C 3/07

(52) U.S. Cl. CPC A62C 3/07

(57) ABSTRACT

The invention relates to a fire protection device comprising a fire protection blanket (3) which can be placed over a potentially burning object positioned on a parking space (5), in particular such as a battery-operated vehicle (6), in order to prevent the spread of fire starting from or across the object. The fire protection blanket (3) is compactly gathered into a bale (32), in particular rolled up and/or folded together, into a roll (32), is accommodated in a box-like housing (1) which is or can be mounted on the parking space (5), and is connected to a pull-out device (4), by means of which the fire protection blanket can be manually or automatically placed completely over the object in the event of fire or risk of fire such that its side portions (31) rest completely or at least largely on the parking space floor on every side in order to prevent as much oxygen influx as possible (FIG. 1).

The invention relates to a fire protection device comprising a fire protection blanket which can be placed over a potentially burning object positioned on a parking space, such as a conventional or, in particular, a battery-operated vehicle, in order to counteract the spread of fire emanating from or spreading to the object, and to a method for preventing or suppressing a fire of an object positioned in this manner.

A fire protection device of this type with a fire protection blanket or extinguishing blanket is disclosed as known in DE 20 2020 106 119 U1. The fire blanket/fire protection blanket is used to cover a battery-powered motor vehicle in particular in order to isolate the fire and thus suppress further spread. The fire blanket is stored folded up in a transport box and the fire protection device has an alarm device that detects when the transport box is removed from its storage location in order to trigger an alarm and request professional assistance, e.g. from the fire department. The fire blanket should withstand the heat of the fire until professional assistance arrives. Positioning the fire blanket over the motor vehicle involves considerable effort, not least because of its relatively high weight, and valuable time is often lost before a fire is detected and contained.

CN 215 461 549 U shows a fire protection device that is mounted above a vehicle, e.g. in a garage, aligned in the longitudinal direction of the vehicle. A fire protection blanket is combined to form two rolls extending in the longitudinal direction, which are held in a central transition area in the longitudinal direction on a holding device with an electromagnet between two half-shells that can be automatically opened laterally in the event of a fire and spread out over a vehicle.

DE 20 2016 008 488 U1 shows a fire protection apparatus article with a fire blanket held in a box, which can be removed through a opening in the lower part of the box without opening the box.

DE 20 2022 101 021 U1 shows a flame protection blanket for covering a motor vehicle with a surface element made of high-temperature fabric.

DE 10 2021 005 719 A1 shows a further fire protection device with at least one flexible fire blanket, which is provided with at least one lashing strap in the form of an endless loop for lashing the fire blanket. Using the lashing strap, the fire blanket can be easily lashed down as required and thus secured to an object, for example.

DE 20 2019 106 371 U1 shows a fire blanket with a three-layer structure consisting of a glass fabric and a second layer of bentonite arranged in between, wherein the structure offers a sufficient compromise in terms of weight, stiffness, fire resistance and gas tightness or filter effect. For handling the fire blanket, it is suggested that it is equipped with handling apparatuses on the edge, such as loop-like handles made of webbing or edge tape. In addition, fastening means, in particular Velcro fasteners, are attached to the edges. The fire blanket is designed to be versatile and effectively protect the surrounding area from the consequences of a lithium-ion battery burning out. Such a fire blanket is also not easy to handle for large-volume objects such as motor vehicles.

DE 10 2016 225 871 A1 shows a fire and smoke protection system with a self-expanding cover comprising a self-tensioning screen. The shielding struts are formed by hose-like lines that can be pressurized with a medium. A commercial vehicle with such a fire and smoke protection system is also proposed, e.g. to shield transported goods in the event of fire or smoke development. The device can also be used for cars in garages or underground garages, for example. Such a structure is relatively complex and the spatial conditions are often unfavorable.

DE 20 2013 102 471 U1 shows an apparatus for emergency care in buildings, comprising a housing or similar, in which means for emergency fighting in the event of fire are provided, such as fire extinguishers or extinguishing blankets. The housing is connected via a radio link to a smoke detector or a control panel to activate the emergency apparatus.

DE 10 2020 102 191 A1 shows a device for detecting an emergency situation in the region of a motor vehicle and a method with which a current value of a status variable of a battery of a vehicle is automatically determined in order to derive an environmental threat and, if necessary, to output an emergency signal.

DE 10 2017 213 408 A1 presents an autonomous loading and unloading vehicle that includes a fire extinguishing apparatus.

The present invention is based on the object of providing a fire protection device of the type mentioned at the beginning, which offers the most effective possible containment of the spread of fire to an object parked in a parking space, in particular a battery-operated vehicle, and of providing a highly effective method of fire protection.

This object is achieved by a fire protection device with the features of claim 1 or by the method according to claim 13. According to the invention, it is provided that the fire protection blanket is compactly combined into a bale, in particular folded up and/or rolled up on a shaft, accommodated in a box-like housing that can be mounted or mounted on the parking space and connected to a pull-out device by means of which it can be placed manually or automatically completely over the object in the event of fire or fire hazard in such a manner that it rests with side portions completely all around on the parking space floor in order to prevent an influx of oxygen as far as possible and thus insulate the vehicle as best as possible.

The method provides for the fire protection blanket to be manually or automatically pulled out of the housing over the object by means of a pull-out device and then lowered.

With these features, the fire protection device offers simple manual operation or also independent, automatic actuation when the fire protection blanket or fire blanket is pulled out completely over the object positioned on the parking space, such as in particular an electrically battery-operated vehicle, and the fire protection blanket is laid down with its edge portions completely or at least largely around the object, so that the spread of fire is effectively counteracted until a fire-fighting team or the fire department arrives and takes over further fire-fighting. The measures according to the invention thus contribute substantially to efficient and early firefighting.

An advantageous design of the housing of the fire protection device mounted or mountable on the parking space is that the housing, which is mounted or mountable with its longitudinal axis in particular transversely or at right angles to the longitudinal direction of the vehicle, is provided with a wall portion covering an extraction opening extending longitudinally to the housing, which can be moved away automatically in the event of a fire hazard in response to an opening signal triggered manually or by means of a sensor arrangement to release the extraction opening. On the one hand, the fire protection blanket with the associated mechanism is protected and vandal-proof in the housing and, on the other hand, is released for use easily and without delay if necessary. For example, the wall portion can be designed as a cover that extends in the direction of the longitudinal axis of the housing and folds downwards or as a sliding cover.

To move the fire protection blanket out of the housing, it is advantageous for the fire protection blanket to be rolled up or folded in the housing and connected to pull-out means.

An advantageous configuration for installation at the parking space for use on the object, in particular a vehicle, is that the housing is mounted in front of the object above it on a parking space boundary, in particular a wall or ceiling, that deflection means are attached to a support part behind and above the object and that two pull-out means, in particular in the form of traction cables, are attached to the fire protection blanket running laterally and above the object in the pull-out direction and are guided around the deflection means, in particular in the form of pull ropes, are attached to the fire protection blanket running laterally and above the object in the direction of extension and are guided around the deflection means, whereby the fire protection blanket can be extended in the direction of extension over the entire length of the object and can then be deposited with edge portions on the floor of the parking space. When the fire protection blanket is pulled over the object, its lateral portions then lie limply on the floor of the parking space as a result of its flexibility and weight, largely preventing airflow from the surroundings to the object. The side portions of the fire protection blanket, as well as the front and rear portions of the fire protection blanket, are large enough to rest on the floor around the parking space.

In order to achieve a quick depositing of the fire protection blanket on the floor, it is advantageously provided that a separating device for separating a connection of the pull-out means from the fire protection blanket or for cutting through the pull-out means is available for depositing the fire protection blanket on the floor behind the object (facing away from the housing). After separating the pull-out means from the fire protection blanket or cutting through the pull-out means themselves, the fire protection blanket can fall unhindered onto the object or vehicle and lie with its side portions on the floor around the vehicle.

An advantageous design for automatic actuation of the fire protection device is that the pull-out device, which is connected in particular to a control apparatus, is coupled to a drive device for automatic pull-out of the fire protection blanket, which can be activated manually or in response to a signal from one or more fire detectors. When triggered by a sensor signal in the event of a fire, the fire protection blanket is positioned above the object as required without the need for human intervention, but can still be adjusted by a user if necessary. At the same time, the alarm signal can be used to trigger an alarm (e.g. acoustic, visual or radio-transmitted) or to switch off the fire alarm system (if available) in order to alert a fire protection officer or the fire department to fight the fire.

There are various possibilities for providing the drive energy for the drive device, for example that an electrical, pneumatic, hydraulic or mechanical energy source, in particular having a spring arrangement, is available to provide the drive energy for the drive device. An advantage here is the presence of a self-sufficient energy source that remains functional even in the event of a fire and in particular without electrical current, such as a pretensioned mechanical spring arrangement whose stored energy is released when an activation signal is triggered, for example by the alarm signal or manual operation, in order to actuate the drive device, such as pulling out the pull-out means via the deflection means for positioning the fire protection blanket over the object.

It is advantageously provided that an electrical, pneumatic, hydraulic or mechanical energy source, in particular having a spring arrangement, is available to provide the drive energy for the drive device.

Furthermore, to pull out and position the fire protection blanket, it is advantageously provided that the drive device is connected to the pull-out means.

A further design that is advantageous for the structure and function is that the drive device is designed as a rotating drive and is provided with a winding device or traction-exerting passage means for the pull-out means. Flow means that can exert a pull on the pull-out means are, for example, friction rollers that transport the pull-out means.

Other advantageous measures for firefighting are that the fire protection blanket is made of high-performance material—which, for example, is designed for temperatures of up to 1,500° C. continuous load (>24 h) or up to 2,500° C. maximum load (approx. 15 min) according to the manufacturer's specifications.

Advantageous adaptation options to local conditions or different object dimensions are obtained by providing a height and/or width adjustment device (H, B, H+B), via which the housing can be mounted or fitted to the parking space in a height and/or width-adjustable manner.

In the method, an advantageous approach is that the pull-out device for pulling out has pull-out means coupled to the fire protection blanket, in particular pull cables, which are guided via deflection elements and are severed in the event of a fire to lower the pulled-out fire protection blanket.

The invention is explained in more detail below by means of examples with reference to the drawings. In the drawings:

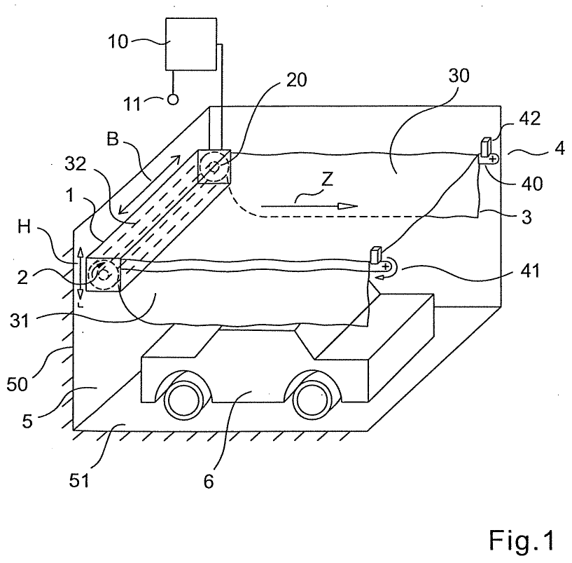

FIG. 1 shows a schematic view of a fire protection device arranged at a vehicle parking space in perspective view.

The embodiment example shown in FIG. 1 schematically depicts a parking space 5 with an object positioned on it and a fire protection device mounted on the parking space, with which the object potentially exposed to fire can be largely protected against the spread of fire, for example until a fire protection assistant or the fire department arrives. In the present case, the object is a vehicle, in particular a vehicle 6 operated electrically by means of a battery (e.g. lithium-ion battery), wherein the parking space 5 can be, for example, a parking space in a garage, approximately an underground garage or carport, or a charging space for charging the battery.

On a front boundary, approximately a solid wall, or a partition wall constructed, for example, from struts, which is located in front of the vehicle in the case of a vehicle parked forwards, preferably at least at the height of the top of the object or of the vehicle 6, for example via a height adjustment device H and/or width adjustment device B, a cassette-like or box-like elongated housing 6 is mounted horizontally (with respect to the direction of gravity or geodesically), which extends approximately across the width of the vehicle 6 or the possible parking space of the vehicle 6. The housing 1 contains a fire protection blanket 3 (also known as a fire blanket) that is compressed into a bale 32, for example rolled up or alternatively folded. The fire protection blanket usually has a standard size of 6×8 m. In the state shown in FIG. 1, the fire protection blanket 3 is largely pulled out of the housing 1 over the vehicle 6 as far as its rear portion (in the pull-out direction Z) and the flexible, relatively heavy fire protection blanket 3 hangs down with lateral portions 31 adjoining an upper portion 30 on both sides, which are folded inwards when rolled up or folded for accommodation in the housing 1, for example. It is also conceivable to make the housing 1 narrower in its longitudinal extension than a vehicle 6, for example, or to make it adjustable in its longitudinal extension to adapt to different parking space widths and to adapt the width of the fire protection blanket 3 to the longitudinal extension of the housing 1, e.g. by folding it once or several times in the longitudinal direction in order to accommodate it therein.

A pull-out device 4 is provided for pulling out the fire protection blanket 3. This has pull-out means, in particular in the form of two lateral pull cables 40, and the pull-out means are coupled to the fire protection blanket 3 in order to pull it out over the vehicle via the pull-out means for pulling out the fire protection blanket 3 in an imminent or already developed fire situation. The pull-out means run over a guide device arranged over the rear of the parking space or rear side of the vehicle, which is provided in particular with a deflection device that has deflection means 41 such as a curved deflection path or deflection rollers. The tensile force for pulling out the fire protection blanket 3 can be applied manually by one or more operators by gripping the pull-out means or, preferably, by means of a drive device 2. The drive device 2 may, for example, be arranged in the region of the deflection means 41 or, preferably, on or in the housing 1, wherein the deflection of the pull-out means is effected via the deflection means 41.

The drive device 2 is driven, for example, by means of an electric motor, pneumatically, hydraulically or mechanically, wherein the energy source is preferably assigned to the fire protection device, so that the drive device is self-sufficiently supplied with energy in the event of a fire. An advantageous embodiment is that the drive energy is stored mechanically in a spring arrangement, for example by means of spiral springs. To pull out the fire protection blanket 3, the pull-out means, for example the pull ropes 40 running laterally in the longitudinal direction of the fire protection blanket in the pull-out direction or laterally of the parking space or vehicle 6 above it, can be rolled up by means of a winding device 20 of the pull-out device 4. For example, the fire protection blanket 3 is unwound from a winding device inside the housing 1 or unfolded from a folded bale.

The fire protection blanket 3 is protected in the safe state, preferably enclosed on all sides in the housing 1. In order to be able to spread it out quickly over the object, in particular vehicle 6, in the event of a fire hazard or fire, a wall portion covering an extraction opening is attached to its front side facing the parking space 5 or vehicle 6, which opens quickly in response to a trigger signal and is designed, for example, as a flap mounted on a hinge and pivoting downwards due to gravity, or alternatively, for example, as a slide or opening upwards by means of spring force. The opening signal can, for example, be triggered manually by a user of the fire protection device or automatically by means of a sensor arrangement 11 that detects a fire hazard or a fire in order to release the extraction opening. An actuator device for releasing the wall portion covering the extraction opening is controlled in particular by means of a control apparatus 10. For example, the opening signal is triggered by an alarm signal from a fire detector, whereupon the pull-out device 4 or the drive device 2 is/are also released or activated.

As soon as the fire protection blanket 3 is extended over the object or vehicle 6, it must be lowered over the object or vehicle 6 so that it rests on the floor 51 around the vehicle with portions at the edges in order to exclude the supply of oxygen to the region of the object under the blanket as far as possible, at least until a fire protection worker or the fire department arrives (after 5 to 20 minutes, for example). The fire protection blanket should at least provide a high level of protection against the spread of fire over such a period of time and can also be left over the object after the arrival of the fire department until the fire has been extinguished or the “thermal runaway” has ended.

The fire protection blanket 3 is designed to meet high fire protection requirements. For example, it has a special coating and is made of highly temperature-resistant material based on silicates or graphite. The flexible blanket is therefore also relatively heavy. In order to lower the extended blanket quickly over the object, a separating device 42 is provided, in particular in the region of the rear deflection means 41, such as a cutting device, with which the pull-out means, in particular the pull ropes 40, are cut or separated from the fire protection blanket 3. In the rear and front regions, the fire protection blanket 3 overlaps the object or vehicle 6 sufficiently so that, after lowering, it rests or fits snugly on the floor 51 with the surrounding portions, also due to its weight. There may also be a separating device in the front region or the front edge region of the fire protection blanket 3 may be loosely accommodated in the housing 6 so that the extended fire protection blanket 3 can simply be lowered to the floor. If additional positioning is required, this can still be carried out by users. Assistance personnel can, for example, be alerted acoustically, visually and/or via a wireless signaling apparats via the fire detector.

In a first embodiment variant, the fire protection device presented here offers manual positioning of the fire protection blanket 3 over a potentially burning object, in particular vehicle 6 on a parking space 5. The fire protection blanket 3 is located for storage in the housing 1 or a wall cassette, which can be mounted or is mounted on a wall 50 of the parking space 5. In this embodiment, the fire protection blanket 3 is positioned over the potentially endangered or already burning vehicle 6 by a user or firefighter. The fire protection blanket 3 can then be adjusted slightly by the user if necessary, taking into account the user's own protection. In this configuration stage, for example, the fire protection device functions completely mechanically and is largely self-sufficient, wherein additional manual operating interventions are provided, such as a trigger signal for opening the cassette and/or pulling out the fire protection blanket 3 with the aid of the pull-out device 4.

In a second variant, the opening of the housing or the cassette can be triggered manually or automatically, for example, and the pull-out process can be triggered by manual actuation, but then runs automatically via the pull-out device 4 and drive device 2.

In a third embodiment variant, automatic triggering of the pull-out device 4 and operation by means of the drive device 2 is provided, triggered by a sensor arrangement 11 and a control apparatus 10, with an at least largely self-sufficient structure, with or without the supply of external energy, possibly also with redundant means. The fire protection device thus offers advantageous protective measures against the risk of fire or in the event of a fire breaking out, particularly in a vehicle 6 powered electrically by a battery, such as a lithium-ion battery. In the latter embodiment variant, it is also advantageously provided that the pull-out process of the fire protection blanket 5 is started via an automatic actuation by means of the sensor arrangement 11, wherein, for example, a two-detector dependency or a dependency with further detectors and an adaptation to the customer's requirements for fully automatic control or regulation can be provided. For this purpose, an interface to a charging station or wallbox can be advantageously provided in order to de-energize it in the event of triggering. This embodiment variant functions, for example, fully automatically in communication with the vehicle 6 and/or a further automated sensor system.

1. A fire protection device comprising a fire protection blanket (3) which can be placed over a potentially burning object positioned on a parking space (5), such as in particular a battery-operated vehicle (6), in order to counteract the spread of fire emanating from or spreading to the object,
characterized in that
the fire protection blanket (3) is compactly combined into a bale (32), in particular rolled up and/or folded together, is accommodated in a box-like housing (1) which can be mounted or is mounted on the parking space (5) and is connected to a pull-out device (4), by means of which it can be placed manually or automatically completely over the object in the event of fire or fire hazard in such a manner that it rests with side portions (31) completely or at least largely all around on the parking space floor in order to prevent an influx of oxygen as far as possible.

2. The fire protection device according to claim 1,
characterized in that
the housing (1) is provided with a wall portion covering an extraction opening, which can be moved away automatically in the event of a fire hazard in response to an opening signal triggered manually or by means of a sensor arrangement (11) to release the extraction opening.

3. The fire protection device according to claim 1,
characterized in that
the fire protection blanket (3) is rolled up or folded in the housing (1) and is connected to pull-out means.

4. The fire protection device according to claim 3,
characterized in that
the housing (1) is mounted in front of the object above it on a parking space boundary, in particular a wall, in the direction of extension,
deflection means are attached behind and above the object on a support part and
two pull-out means, in particular in the form of pull ropes (40), are attached to the fire protection blanket (3) at the side and above the object, running in the pull-out direction, and are guided around the deflection means, with which the fire protection blanket (3) can be pulled out in the pull-out direction over the entire length of the object and can then be deposited with edge portions on the floor (51) of the parking space (5).

5. The fire protection device according to claim 4,
characterized in that
a separating device (42) for separating a connection of the pull-out means from the fire protection blanket (3) or the pull-out means themselves is provided for depositing the fire protection blanket (3) on the floor (51) behind the object.

6. The fire protection device according to claim 1,
characterized in that
the pull-out device (4), which is connected in particular to a control apparatus (10), for automatically pulling out the fire protection blanket is coupled to a drive device (2), which can be activated manually or in response to a signal from a fire detector.

7. The fire protection device according to claim 6,
characterized in that
an electrical, pneumatic, hydraulic or mechanical energy source, in particular having a spring arrangement, is present for providing the drive energy of the drive device (2).

8. The fire protection device according to claim 7,
characterized in that
the energy source is arranged on or in the housing (1).

9. The fire protection device according to claim 6,
characterized in that
the drive device (2) is connected to the pull-out means.

10. The fire protection device according claim 6,
characterized in that
the drive device (2) is designed for rotating drive and is provided with a winding device (10) or traction-exerting passage means for the pull-out means.

11. The fire protection device according to claim 1,
characterized in that
the fire protection blanket is made of high-performance material—which is designed for temperatures of up to 1,500° C. continuous load (>24 h) and/or up to 2,500° C. maximum load (up to approx. 15 min).

12. The fire protection device according to claim 1,
characterized in that
a height and/or width adjustment device (H, W, H+W) is provided, via which the housing can be mounted or fitted to the parking space in a height and/or width-adjustable manner.

13. A method of preventing or suppressing a fire starting from or spreading to an object, in particular a vehicle (6), positioned on a parking space, in which a fire protection blanket (3) accommodated in a housing (1) as a rolled-up or folded-up bale (32) is released and prepared over the object with edge portions placed on the ground,
characterized in that
the fire protection blanket (3) is manually or automatically pulled out of the housing (1) over the object by means of a pull-out device (4) and then lowered.

14. The method according to claim 13,
characterized in that
the pull-out device (4) has pull-out means coupled to the fire protection blanket (3) for pulling out, in particular pull cables (40), which are guided via deflection elements and are severed in the event of fire in order to lower the pulled-out fire protection blanket (3).
